(19) United States
(12) Patent Application Publication
(10) Pub. No.: US 2025/0214779 A1
(43) Pub. Date: Jul. 3, 2025

(54) SYSTEMS AND METHODS OF CONTROLLING THE LOADING OF PACKAGES IN FULFILLING ORDERS

(71) Applicant: Walmart Apollo, LLC, Bentonville, AR (US)

(72) Inventors: Sharath Dadadahalli Prakash, North Caldwell, NJ (US); Vikranth Gopalakrishnan, Monmouth Junction, NJ (US); Mohamed M. Ayoub, Avon, IN (US); Olena Wilson, Parkland, FL (US)

(21) Appl. No.: 18/867,245

(22) PCT Filed: May 24, 2023
(86) PCT No.: PCT/US2023/023350

§ 371 Date: Nov. 19, 2024

Related U.S. Application Data
(60) Provisional application No. 63/346,548, filed on May 27, 2022.

(51) Int. Cl. B65G 1/137; B65B 5/10; B65B 59/00; G06Q 10/087

(52) U.S. Cl. CPC B65G 1/1378; B65B 5/105; B65B 59/003; B65G 1/1371; G06Q 10/087

(57) ABSTRACT

Some embodiments provide order packaging control systems, comprising: a product packaging (PP) control circuit communicatively couple with an automated custom package fabrication (CPF) system configured to fabricate on demand custom packages, an automated product retrieval (PR) system configured to autonomously retrieve one or more products, pick stations, and a set of sensor systems. The PP control circuit can be configured to receive orders; prioritize the orders and define an order fulfillment sequence, track states of the PR system and the CPF system; determine product retrieval timing, and correspondingly determine fabrication timing of when the CPF system is to fabricate corresponding packaging; and control the PR system and the CPF system in controlling synchronous operation of the PR system and the CPF system to synchronize an availability of products of an order at a pick station and an availability of a custom package at the pick station.

### CROSS-REFERENCE TO RELATED APPLICATION

This application claims the benefit of U.S. Provisional Application No. 63/346,548 filed May 27, 2022, which is incorporated herein by reference in its entirety.

### TECHNICAL FIELD

This invention relates generally to the control and distribution of items.

### BACKGROUND

Product distribution can be critical to retail entities. This distribution can include preparing products for shipping. Similarly, the distribution can additionally or alternatively include preparing the preparation of and the delivery of products.

### BRIEF DESCRIPTION OF DRAWINGS

Disclosed herein are embodiments of systems, apparatuses and methods pertaining to the control of product distribution. This description includes drawings, wherein:

FIG. 1 illustrates a simplified block diagram of an exemplary order packing control system of an exemplary order fulfillment system, in accordance with some embodiments.

FIG. 2 illustrates a simplified block diagram, overhead view of an exemplary pick station, in accordance with some embodiments.

FIG. 3 illustrates a simplified functional block diagram of an exemplary multi-phase fulfillment system, in accordance with some embodiments.

FIG. 4 illustrates a simplified functional representation of an exemplary process of controlling the picking and packaging of products, in accordance with some embodiments.

FIG. 5 illustrates a simplified flow diagram of an exemplary process of fulfilling product orders, in accordance with some embodiments.

FIG. 6 illustrates a simplified flow diagram of an exemplary process of controlling retrieval of product and package fabrication and/or retrieval of pre-fabricated packages.

FIG. 7 illustrates a simplified flow diagram of an exemplary process of controlling the loading of a package, in accordance with some embodiments.

FIG. 8 illustrates a simplified flow diagram of an exemplary process of completing a loading of a particular package and/or completing a packaging of an order into a partially loaded package, in accordance with some embodiments.

FIG. 9 illustrates an exemplary system for use in implementing methods, techniques, devices, apparatuses, systems, servers, sources and providing control over product distribution and/or packaging, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Some present embodiments provide fulfillment systems and fulfillment facilities in part by controlling the intake and storage of products, and the synchronized distribution of products to pick stations with the distribution of custom and/or prefabricated packaging to those pick stations to enhance the packaging of products of one or more products to be distributed from the facility in fulfilling product orders. The enhanced system greatly improves the speed and accuracy of order fulfillment, while significantly reducing packaging material usage.

In some embodiments, provide order packaging control systems that include one or more product packaging (PP) control circuit comprising at least one processor and memory communicatively coupled with the processor. The PP control circuit is configured to communicatively couple over one or more distributed communication networks with one or more automated custom package fabrication (CPF) systems configured to fabricate on demand custom packages according to custom sizing as a function of one or more products intended to be shipped, one or more automated product retrieval (PR) systems configured to retrieve one or more products of orders being received over time, one or more pick stations cooperated with one or more CPF systems and one or more PR systems, and a set of sensor systems configured to detect positions of custom packages and products as they are transported to and from the pick stations. The PP control circuit, in some embodiments, is configured to receive over time, from one or more product order systems, the orders. The orders can be prioritized as a function of the one or more products of each of the orders and inventory levels, and an order fulfillment sequence can be defined based on the order prioritization. The PP control circuit tracks, based on sensor data, states of the PR system and the CPF system in determining product retrieval timing of when the one or more products for each of the orders is to be retrieved as a function of the order prioritization, and correspondingly determines fabrication timing of when the CPF system is to fabricate corresponding packaging as a function of a package fabrication queue. One or both of the PR system and the CPF system can be controlled through one or more instructs in controlling the synchronous operation of the PR system and the CPF system, as a function of the tracking and order prioritization, to synchronize the availability of the one or more products of a first order of the orders at a first pick station of the pick stations and the availability of a first custom package at the first pick station.

In some embodiments provide methods of fulfilling product orders. Orders for products from a retailer are received over time, at a product packaging (PP) control circuit and from one or more product order systems. The PP control circuit is configured to communicatively couple over one or more distributed communication networks with an automated custom package fabrication (CPF) system configured to fabricate on demand custom packages according to custom sizing as a function of one or more products intended to be shipped, and an automated product retrieval (PR) system configured to retrieve one or more products of orders being received over time. The orders can be prioritized as a function of the one or more products of each of the orders and inventory levels, and defining an order fulfillment sequence based on the order prioritization. States of the PR system and the CPF system are tracked based on sensor data received from a set of sensor systems configured to detect positions of custom packages and products as they are transported to and from pick stations, to determine product retrieval timing of when the one or more products for each of the orders is to be retrieved as a function of the order prioritization, and correspondingly determine fabrication timing of when the CPF system is to fabricate corresponding packaging as a function of a package fabrication queue. One or both of the PR system and the CPF system are controlled in controlling synchronous operation of the PR system and the CPF system, as a function of the tracking and order prioritization, to synchronize the availability of the one or more products of a first order of the orders at a first pick station of the pick stations and the availability of a first custom package at the first pick station.

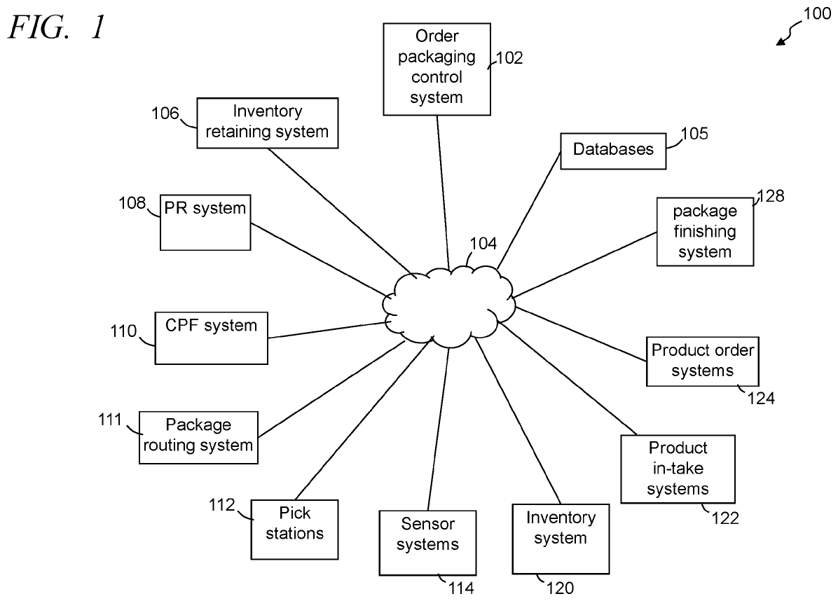

FIG. 1 illustrates a simplified block diagram of an exemplary order packing control system 100 of an exemplary order fulfillment system, in accordance with some embodiments. The order packaging control system 100 includes one or more product packaging (PP) control circuits 102 each comprising at least one processor and memory communicatively coupled with the processor storing software and/or applications executed by the processor. The one or more PP control circuits 102 are typically communicatively with one or more distributed wired and/or wireless communication networks 104. The communication networks can include substantially any relevant communication such as but not limited to local area network (LAN), wide area network (WAN), the Internet, cellular network, Wi-Fi network, BLUETOOTH network, other such communication networks or a combination of two or more of such wired and/or wireless communication networks. The one or more PP control circuits 102, in some embodiments, is/are implemented through one or more processors, computers, servers and/or other such computing systems that are communicatively coupled over one or more of the distributed communication networks 104 and/or other distributed networks. Further, the one or more PP control processors, computers, servers and/or other such computing systems of the one or more PP control circuits 102 can be geographically distributed and configured to cooperatively operate to provide redundancy, distributed processing, compensate for potential failures at one or more locations and/or geographic areas, provide distributed computer memory and/or storage to enhance access speed and/or reliability, and other such benefits. Some embodiments include one or more databases 105 that store relevant information and are accessible to one or more of the systems of the order packaging control system 100 and/or other systems. The databases can store customer information and/or profiles, order information, inventory information, product information and/or profiles, location information, status information, log information, other such information, and typically a combination of two or more of such information. Further, the databases can be implemented through one or more memories, computers, servers and/or other systems that can be geographically distributed and communicatively coupled with the communication network 104. The distribution enables redundancy, protection, improved access, and/or other such benefits.

In some embodiments, the order packing control system 100 includes or is cooperatively operated with one or more inventory retaining systems 106 that are configured to receive and store inventory used to fill orders for products from customers, which can include individuals, businesses, other retail facilities of a retailer, other retailers, and/or other such entities ordering products to be delivered and/or picked up. The inventory retaining system can include shelves, racks, receptacles, floor space, bins, refrigeration systems, heating and/or cooking systems, compartments, lockers, other such devices that can receive and store products. Further, in some embodiments, the inventory retaining systems 106 can include one or more processors, computers, servers, sensor and/or other systems that track inventory, track levels of inventory, track occupied space in the one or more inventory retaining systems 106, track unoccupied space in the one or more inventory retaining systems 106, track locations of inventory items, racks, shelves, lockers and other components of the inventory retaining system 106, other such functionality or a combination of two or more of such functionality.

The order packing control system 100, in some embodiments, can include and/or is cooperatively operated with one or more automated product retrieval (PR) systems 108 that are each configured to retrieve one or more products from the one or more inventory retaining systems 106 of orders being received over time. In some instances and/or for some products, the PR system autonomously retrieves one or more products. In other instances and/or for some products the PR system and/or the PP control circuit issue commands to utilize other systems and/or methods of retrieval, which can include notifying one or more workers to retrieve. The PR systems can, in some embodiments, further place products into and/or return products to one or more of the inventory retaining systems (e.g., as part of an ingest and/or decanting process). In some embodiments, one or more of the PR systems 108 include one or more forklifts, one or more pallet carts, hoists, one or more carts, one or more robotic devices, one or more drones, one or more cranes, one or more manipulator arms, one or more conveyors (e.g., belts, rollers, rails, tracks, etc.), other such systems, or a combination of two or more of such systems.

In some embodiments, the one or more PR systems 108 can include one or more processors, computers, servers, sensor and/or other systems (e.g., processors and/or computers of drones, vehicles, robotic systems, etc.) that provide, in part, operational functionality to such systems and enable communication to and/or from these systems. Further, some embodiments incorporate automated and/or partially automated systems that utilized unmanned vehicles to retrieve products, containers, bins and/or totes of one or more products, and/or other systems of storing products. Additionally or alternatively, the PR system 108 can utilize human workers to retrieve some or all of the products, and/or to route and/or move products through the facility to intended locations (e.g., pick station, storage location, loading area, etc.). Some embodiments incorporate the some or all of the storage and retrieval systems, vehicles, methods and/or processes described in U.S. Pat. No. 10,769,587, entitled SYSTEMS AND METHODS OF STORING AND RETRIEVING RETAIL STORE PRODUCT INVENTORY, some or all of U.S. Pat. No. 11,179,845, entitled DISTRIBUTED AUTONOMOUS ROBOT INTERFACING SYSTEMS AND METHODS, and/or some or all of U.S. Patent Application Publication No. 2019/0333006, entitled SYSTEM AND METHOD FOR AUTOMATED FULFILLMENT OF ORDERS IN A FACILITY, which are each incorporated herein by reference in their entirety.

In some embodiments, the order packing control system 100 further includes one or more automated custom package fabrication (CPF) systems 110 configured to fabricate on demand custom packages according to custom sizing as a function of one or more products intended to be shipped. Typically, the CPF systems 110 are communicatively coupled over one or more of the communication networks 104 with the PP control circuit 102. The CPF systems 110, in some embodiments, utilize dimensions of the one or more products as part of factors in determine a size, shape, volume, material and/or other factors used in fabricating one or more customized packaging (e.g., box, bag, carton, envelope, platform, tube, etc.) specific for the one or more products of the specific order to be packaged within the custom fabricated package. One or more algorithms, processes, machine learning systems and/or other such methods can be employed in determining a size, shape, interior volume, type of packaging material, type and/or amount of protection material(s), and/or other such factors in designing and fabricating the customer package. In some embodiments, for example, the CPF system 110 applies a cubing algorithm, which considers the dimensions of the one or more products in addition to one or more other order characteristics to define the dimensions of a customized packaging. The characteristics can include, but are not limited to one or more of: types of products, frangibility, predicted mode(s) of transport, temperature restrictions and/or requirements, predicted protective packaging type(s) and/or quantities, duration of transport to destination, type of material used in fabrication, other such characteristics or a combination of such characteristics. In some implementation, the cubing, determining of product arrangement, determination of product dimensions and/or determination of custom package dimensions, materials, and other such characteristics can be partially or fully implemented in accordance with the systems, methods and processes described in U.S. patent application Ser. No. 17/308,689, entitled SYSTEMS AND METHODS FOR ASSEMBLING UNPACKED MERCHANDISE IN CONTAINERS, which is incorporated herein by reference in its entirety. In some embodiments, some or all of the CPF system is implemented through one or more systems from Packsize International, Inc., such as the X4 or X7 systems, or other similar systems.

The order packing control system 100 further includes a package routing system 111 that is part of and/or cooperated with the CPF system 110. The package routing system 111 receives custom fabricated packages and/or pre-fabricated packages (e.g., boxes, bags, cartons, envelopes, platforms, tubes, etc.) and routes those packages to assigned pick stations 112 that are intended to utilize the packages in fulfilling at least a part of a product order that is associated with the particular package. As described above, in some embodiments packages ore the custom fabricated or pre-fabricated package is specifically retrieved for a particular order based on one or more factors. Accordingly, the package is associated with the particular order and the PP control circuit 102 controls the retrieval and routing of the package corresponding to the particular order and the products for the particular order to the same pick station. The pre-fabricated packages (e.g., boxes, bags, cartons, envelopes, platforms, tubes, etc.) can be fabricated through the CPF system (e.g., based on a predicted need, in an effort to increase throughput, in an effort to reduce overhead, in response to quantities and/or variations in packaging materials used to fabricate packages, and/or other such factors) and/or ordered from one or more suppliers and stored at the facility for use in packaging products in preparation for distribution to a customer and/or a subsequent facility (e.g., a retail store, another fulfillment facility, a distribution facility, other such locations, or the like).

The order packing control system 100 can further cooperate with, communicate with and/or include one or more pick stations 112 that each cooperate with the CPF system 110 and the PR system 108. The pick stations, in part, are configured to receive products that have been ordered in preparation for making those products ready for the respective customer, such as packaging the product, labeling the product and/or packaging, sorting products, separating products, other such activities, or a combination of two or more of such activities. In some embodiments, the pick stations are occupied by one or more human associates that perform some or all of the picking functions. Additionally or alternatively, in some embodiments one or more of the pick stations 112 can include one or more automated picking systems that can perform one or more of the pick functions. As a non-limiting example, one or more of the pick stations 112 can include an automated manipulating arm that can retrieve products from a tote or other such container that has been transported to the pick station. Similarly, the automated manipulating arm can additionally or alternatively be configured to place one or more products into one or more respective packaging (e.g., box, bag, wrapping, flexible carton, bin, tote, and/or other such packaging)

One or more sets of sensor systems 114 are typically further included in the order packing control system 100. These sensor systems 114 can be configured to detect and/or track over time positions of packages (e.g., customer and/or prefabricated boxes, customer and/or prefabricated bags, customer and/or prefabricated wrappings, customer and/or prefabricated flexible cartons, bins, totes, and/or other such packaging) and/or products as they are transported to and from the pick stations, received at the facility, decanted, routed to the inventory retaining system, routing to loading stations, loaded into transport vehicles, routed to customer staging areas, picked up, and/or other such movement. Similarly, in some embodiments some of the sensor systems can be configured to further detect and/or track over time locations, status, states of operation and/or other such factors associated with drones, robotic systems, vehicles, conveyors, and/or other such systems of the order packing control system 100 and/or systems cooperatively operating with the order packing control system. The sensor systems can include one or more motion sensing systems, identifying readers (e.g., bar code readers, QR code readers, RF identifying (RFID) tag detectors, cameras, image processing systems, weight sensor systems, accelerometers, gyroscopes, other such senor systems, or a combination of two or more of such sensor systems. The foregoing examples are intended to be illustrative and are not intended to convey an exhaustive listing of all possible sensor systems. Instead, it will be understood that these teachings will accommodate sensing any of a wide variety of circumstances in a given application setting. Further, some embodiments utilize sensor systems of other systems, such as sensor systems of the inventory retaining system 106, the PR system 108, the CPF systems 110, the pick stations 112, the inventory system 120, the product in-take systems 122, the product order systems 124, drones and/or automated vehicles, sensor systems of vehicles, sensor systems carried and/or transported by workers and/or customers, and other such systems.

In some embodiments, the order packing control system 100 further includes and/or communicatively couples with one or more inventory systems 120 that are configured to track and maintain inventory information about products in one or more facilities in which the packing control system is associated and/or track and maintain inventory information about inventory at other facilities, in transit and/or other such inventory information. The inventory system, in some implementations, can be implemented through one or more processors, servers, computers and/or other such systems that communicatively couple and cooperate over one or more of the distributed communication networks 104. The inventory system 120 can supply inventory information to the PP control circuit 102 and/or PR system 108, which can be used to identify particular products, totes, bins and the like to be retrieved, locations of where particular products are located, product quantity information, other such inventory information, and typically a combination of two or more of such inventory information.

In some embodiments, the order packaging system 100 includes one or more package finishing systems 128. Outbound loaded packages containing one or more products for an order can be conveyed from the pick stations 112 to the package finishing system 128 to receive protective packaging and/or dunnage, sealed and in some instances labeling applied (e.g., printed, sticker, etc.). In some implementation the package finishing system 128 is divided into multiple lanes along which packages are routed. Along each of the lanes a worker and/or automated protective packaging system incorporate protective packaging when needed (e.g., e.g., worker manually filling the void inside the package with dunnage). In some embodiments, one or more of the lanes includes one or more sealing systems that seal one or more openings of the package (e.g., sealing a top and/or bottom of a box, securing an opening of an envelope, etc.). For example, some systems include a semi-automatic taping machine that is operated to apply relevant tape to close a package. In some embodiments, package finishing station and/or one or more of the lanes includes the labeling systems to apply identifying information, shipping and/or routing information, other identifying information, instructions and/or handling cautions (e.g., “This Side Up”, “Fragile”, etc.), warning notifications (e.g., Hazmat or VAS items) and/or other such labeling. In some embodiments, the lanes include lane interfaces that can provide textual, graphical and/or pictorial instructions to a worker when labeling is manually applied (e.g., prompt to place one or more labels on appropriate locations of a package through a user interface). Some embodiments include a confirmation system that confirms appropriate placement of labeling. The confirmation system can include one or more scanners (e.g., bar code scanner, QR code scanner, RFID reader, camera and image processing, and/or other such scan systems).

As described above, in some embodiments, the order packing control system 100 includes and/or cooperates with one or more product in-take systems 122 that process products received at the facility and prepares the products for distribution to the pick stations 112. As such, the order packing control system 100 can include and/or cooperatively operate with in-take transport systems (e.g., conveyor systems, vehicles, drones, robotic devices, etc.) that are used to move products from one or more shipping and/or receiving areas of the facility to storage locations awaiting to be retrieved by the PR system 108. In some implementations, one or more products can be separated out into individual eaches or items (e.g., from a case of the items). Further, some products may be temporarily stored in containers, bins, totes or the like for storage. Still further, in some instances, different types of products can be stored in a single container, while in other instances products might not be mixed. The in-take systems 122 typically communicate with the inventory system 120 to maintain accurate inventory information as products are received, decanted and stored. Further, in some embodiments, the sensor systems 114 include sensor systems that detect states, conditions, positions and/or movement of products, the transport systems and/or other components of the in-take systems. In some embodiments, some or all of the in-take transport systems may be part of the PR system 108 and/or be used in both in-take as well as transport to pick stations 112, to load stations or areas in preparation for loading into vehicles, to customer staging areas in preparation for customers receiving products from the facility, and/or other such movement.

In some embodiments, the fulfillment system includes the product in-take system 122 and the order packaging control system 100. Products are received at the facility at one or more loading locations (e.g., loading bay, loading dock, etc.) and transported using the in-take system 122 to move products through the facility to storage locations within one or more of the inventory retaining systems 106, which in some instances is similar to and/or part of the PR system 108. The loading locations, in some implementations, are similarly used to move products out from the fulfillment facility (e.g., for delivery to intended customers, retail facilities, other fulfillment facilities, and/or other intended destinations). Some embodiments incorporate scanning and/or other identification of products and the placement within the facility. For example, prior to placement each product can be scanned (e.g., bar code, QR code, image recognition, other such methods or a combination of two or more of such methods), and one or more location identifiers can similarly be scanned (e.g., bar code, QR code, image recognition, other such methods or a combination of two or more of such methods) providing an identification of the location of the product within the facility and/or the one or more inventory retaining systems 106. As described above, in some instances containers, bins or totes can be used to temporarily house products that are placed into the PR system 108. These containers can be one size or in other instances can included various sized containers. One or more products may be placed into a container. Further, in some embodiments, different types of products can be included into a single container. Typically, product identifying information is captured (e.g., bar code scan, QR code scan, image capture and image processing, etc.) prior to, while or after added to the container and the container identifying information is similarly captured and associated with the product (e.g., in the inventory system 120. The container identifier can similarly be captured in association with a storage location enabling association of that location to the one or more products in the container. Utilizing the inventory information that includes location information, the PP control circuit can control the PR system through one or more instructions and/or information provided to the PR system to cause the PR system to retrieve relevant products in collecting one or more products for products orders that are being at least partially fulfilled through the order packaging control system 100.

The order packaging control system 100 further includes and/or is in communication with one or more product ordering systems 124 that are configured to receive orders for one or more products from customers, other retail facilities, other retailers and/or other such individuals and/or entities requesting products. The product ordering system 124, in some embodiments, is implemented through one or more processors, computers, servers and/or other such computing systems that are communicatively coupled over one or more of the distributed communication networks 104 and/or other distributed networks. Further, the one or more processors, computers, servers and/or other such computing systems of the product ordering system 124 can be geographically distributed and configured to cooperatively operate to provide redundancy, distributed processing, compensate for potential failures at one or more locations and/or geographic areas, provide distributed computer memory and/or storage to enhance access speed and/or reliability, and other such benefits.

The PP control circuit 102, in some embodiments, is configured to receive the orders over time, from the one or more product order systems 124. Again, the orders can be for one or more products requested by a respective customer, retailer facility, retailer, and/or other such requestor. The one or more products in each order are known and in some embodiments the inventory system 120, the PP control circuit 102 and/or an external source maintain one or more product profiles associated with the respective product with information about the product, such as but not limited to size, dimensions, weight, type, frangibility, packing instructions and/or restrictions, storage temperature thresholds, shipping temperature thresholds, expiration information, priority information, other such information, and typically a combination of two or more of such factors. Similarly, the order is typically associated with an intended entity ordering the product and/or receiving the product. Entity or customer profiles may similarly be maintained by a customer management system, the PP control circuits and/or an external source. These entity profiles can maintain information about the customer or entity such as a geographic location associated with the entity, one or more delivery addresses associated with the entity, preferences, purchase history information, shopping history information, a customer level or hierarchy associated with the customer that may relate to different benefits and/or restrictions, other such information or a combination of two or more of such information. Still further, in some embodiments, the order and/or products ordered may be associated with restrictions, conditions and/or factors that are considered in evaluating when, where and/or how an order should be partially or fully filled at a respective facility and/or multiple facilities.

In some embodiments, the PP control circuit 102 and/or the product order system 124 can be configured to prioritize the orders or parts of the orders based on one or more factors. As one non-limiting example, the order prioritization can be determined as a function of the one or more products of each of the orders and inventory levels. Further, the order prioritization can additionally or alternatively take into consideration product parameters specified in one or more product profiles and/or accessed from one or more other sources, customer parameters specified in one or more customer profiles, whether a single order is to be separated into multiple sub-orders and/or part of an order is to be fulfilled at separate pick stations and/or separate facilities, expected customer receiving time and/or date, a method by which the customer is to receive the one or more product (e.g., picked up at the facility, delivered to a different facility for pickup, delivered, etc.), rates of fulfillment at one or more fulfillment facilities, an order fulfillment capacity of one or more fulfillment facilities and/or pick stations, available packages and/or packaging materials, rate of package production, other such factors, or a combination of such factors. These factors may be known, estimated, predicted and/or vary over time. Further, the one or more weightings may be applied to some or all of the factors that can affect the defined prioritization of an order and/or a product of an order. Further, in some embodiments, the PP control circuit and/or the product order system 124 can combine some or all of two or more orders into a single order or grouped order. This combination can be based on one or more factors such as but not limited to an intended recipient, a destination of the orders, an association between the entities ordering, an association between entities receiving (e.g., spouses, parent-child, co-workers, etc.), other such factors, or a combination of two or more of such factors. This single or grouped order can then be prioritized similar to or the same as other orders. In some instances, the grouping may have an affect on prioritization (e.g., increasing a priority because of reduced cost, increasing a priority because of a time sensitivity to one of the products of the grouped order, decreased priority because of a separation out of one or more products that might cause a higher priority, a change in priority because of an expected size of the custom package for the grouped order, etc.).

Based on the order prioritization and/or one or more of the above identified factors, and/or other factors, the PP control circuit 102, in some embodiments, define one or more order fulfillment sequences specifying a sequence or progression of which orders are to be processed to fulfill at least part of the respective order from the one or more facilities. Typically, the one or more fulfillment sequences are continuously modified and/or changed over time. This enables the incorporation of new orders received (e.g., which may be designated with a higher priority that one or more orders already incorporated into the sequence) and/or a re-prioritization of one or more orders over time as varying conditions may change and/or are predicted to change that are associated with one or more of the factors considered in prioritizing (e.g., change in temperature, change in a rate of fulfillment, change to an order, variations in inventory levels, change in product demand, other such potential variations, or a combination of two or more of such variations). In some embodiments, multiple fulfillment sequences are produced, such as a fulfillment sequence for two or more pick stations 112, fulfillment sequence for different sets of pick stations, fulfillment sequence for different portions or zones of a fulfillment facility, fulfillment sequency for groupings of orders (e.g., based on types of products, locations of products within a facility, subsystems of the PR system 108 expected to be employed in retrieving products, other such groupings, or a combination of such factors in grouping).

The PP control circuit 102, in some implementations, further tracks, based on sensor data, states of the PR system 108, the CPF system 110, one or more of the pick stations 112, other such systems or two or more of such systems. In some embedment's, the PP control circuit 102 additionally or alternatively considers other factors in determining states of operation and/or processing by the PR systems, CPR system, pick stations, and/or other systems. For example, the determination of states of operation can further consider factors such as but not limited to a current order being addressed, a rate of orders or parts of orders processed, aspects of a queue of orders to be addressed (e.g., quantity of orders, complexity of orders (e.g., number of products, distribution of products within the facility, inventory levels, etc.), predicted variations (e.g., scheduled maintenance, scheduled shift change of workers, scheduled downsizing of workers, etc.), and/or other such states of order processing and/or operation.

Based on the determined states of operation and/or processing of orders the PP control circuit 102, the PR system 108 and/or the CPF system 110 can be configured to determine product retrieval timing of when the one or more products for each of the orders is to be retrieved by the PR system as a function of the order prioritization. In some embodiments, the PP control circuit 102 can correspondingly determine, based on the retrieval and/or states of the systems, a package retrieval schedule of pre-fabricated packaging and/or a package fabrication timing and/or schedule of when the CPF system 110 is to fabricate corresponding packaging for orders as a function of a package fabrication queue. Typically, the product retrieval timing, package retrieval timing and/or package fabrication timing are synchronized and controlled with the intent that packages, whether custom-fabricated or retrieved, are prepared and routed to a particular pick station 112 to be available at the pick station within a threshold time of a predicted arrival at the particular pick station of at least one of the one or more products of an order being fulfilled at the particular pick station.

The PP control circuit 102 is configured to control one or both of the PR system 108 and the CPF system 110 in controlling the synchronous operation of the PR system and the CPF system, as a function of the tracking and order prioritization, to synchronize the availability of the one or more products of one or more product orders at a particular pick station 112 and the availability of a custom package and/or pre-fabricated package at the particular pick station. Accordingly, in some embodiments, depending on the number of pick stations, the order packing control system 100 can be configured to coordinate the movement of products and custom packages and/or prefabricated packages to enable the picking and packaging of thousands to tens of thousands or even hundreds of thousands of products a day from a single fulfillment facility.

Some embodiments include one or more package labeling systems that are part of and/or cooperate with the CPF system 110 and/or are positioned relative to the pre-fabricated packaging. The package labeling systems can be configured to generate and apply order identification information on an exterior and/or interior of the respective package. The order identification information identifies the order with which the particular pre-fabricated or custom fabricated package is intended. For example, the labeling system can print, paint or other such method a label, a “license plate” or other such identifying indicator directly on the package, on a sticker that is applied to the package, or the like. The identifying information can include one or more bar codes, one or more QR codes, one or more order numbers, a string of one or more alphanumeric and/or symbolic characters, other such identifiers or a combination of such identifiers that identify the order with which the package is assigned. The PR system 108 can control the transportation of the pre-fabricated and/or fabricated packages to the respective pick stations 112 assigned to fulfill at least part of the order for which the package is assigned. Some embodiments utilize sensor systems to identify and track the packages based on the identifying information and use that to control the PR system in routing the packages to the appropriate pick stations.

In some embodiments, one or more of the pick stations 112 are each configured to buffer and temporarily hold different queued packages retrieved and transported to the pick station to await loading, while other packages continue to be delivered to the respective pick station and one or more other products are packaged with each of the other packages. The multiple different queued packages are temporarily held at the respective pick station in accordance with a station package queue as a function of the synchronized control of the PR system 108 and the CPF system 110 in positioning the respective queued packages to be available when the one or more products of a respective one of the orders are available to be packaged in a respective one of the queued packages.

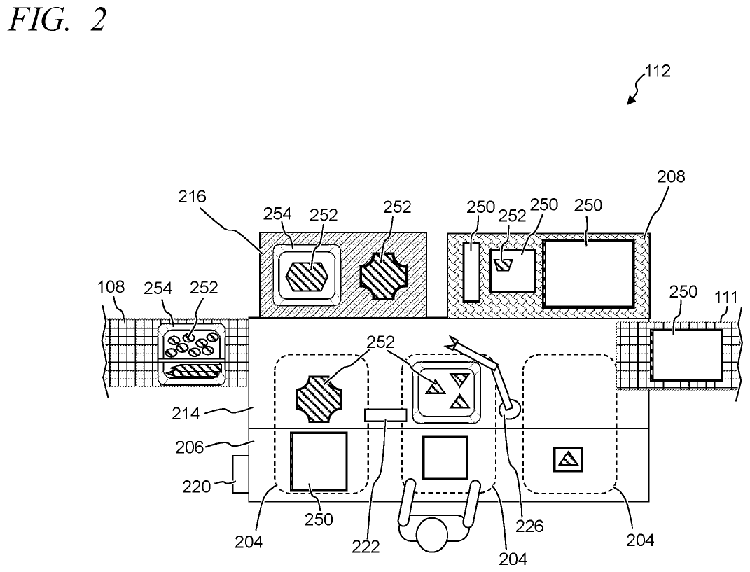

FIG. 2 illustrates a simplified block diagram, overhead view of an exemplary pick station 112, in accordance with some embodiments. The pick station 112 is cooperated with the PR system 108 (e.g., conveyor(s), drones, etc.) that transports products 252 to and/or from the pick station 112. Similarly, in some embodiments, the pick stations 112 are cooperated with the package routing system 111 to enable the packages to be transported to and/or away from the pick station. In other embodiments, some or all of the CPF system 110 is implemented as part of the pick station and/or picked products are routed to the CPF system. FIG. 2 illustrates a single feed of the PR system 108 and single feed of the package routing system 111. It will be appreciated by those skilled in the art one or more feeds of the PR system 108 and/or the package routing system 111 can be cooperated with the pick station 112. For example, the pick station may be cooperated with one or more source feeds of the package routing system 111 delivering packages to the pick station (e.g., unloaded, recently fabricated package specific to a particular order), and one or more exit feeds that route loaded and/or partially loaded packages away from the pick stations.

Similarly, the pick station may be cooperated with one or more source feeds of the PR system 108 to receive products, and one or more exit feeds of the PR system 108 to return products and/or partially loaded packages to respective storage locations of the PR system and/or other storage system. In some implementations, for example, one or more products are received in a container 254 (e.g., tote, bin, package, and/or other such receptacle) that is configured to house one or more of the same and/or different products. In some instances, the container is reusable. Identifiers of the respective products are captured prior to and/or as these products are placed into the container and a corresponding identifier of the container 254 is detected. The container identifier is associated with the product identifier in the inventory system 120, an inventory database or the like, enabling accurate identification of the location of the products. The location or placement of the container within the PR system 108 is further associated with the container identifier and/or product identifiers to enable routing to the appropriate storage location when one of the products within the container is ordered. The use of container 254 can be beneficial for many products. Other products, however, may not be associated with a container and instead stored individually. As one non-limiting example, products having one or more dimensions greater than one or more interior dimensions of the container 254 may be stored individually, in different types of containers, and/or in different locations. One or more sizes of containers further may be used. Similarly the PR system 108 may provide different sized storage locations and/or some or all storage locations may be configured to enable multiple storage locations to be cooperatively used for a single container and/or single product. The PR system 108 can be utilized to route containers 254 and/or unpicked products away from the pick station 112 (e.g., back to a predefined or newly assigned storage location, an empty container holding area, and/or other such locations).

The pick station 112, in some embodiments, includes one or more packing positions 204 where one or more products 252 for an order are positioned and a corresponding package 250 is positioned to receive the one or more products. In some embodiments, one or more workers or associates can be positioned at the pick station and retrieve a product 252 at the pick station and cooperate the product with the appropriate corresponding package 250. Additionally or alternatively, in some embodiments one or more of the pick stations 112 can include one or more automated picking systems 226 that can perform one or more of the pick functions.

The pick station 112 typically includes one or more pick station control circuits 220 that receive and/or track the order queue(s) and controls the pick station to enable the worker and/or automated system to pack the products. In some implementations, the pick station includes one or more user interfaces (e.g., display(s), keyboard(s), keypad(s), button(s), mouse, touchscreen, touchpad, etc.) that enables the user to at least receive information from the pick station control circuit 220 and/or the PP control circuit 102. For example, the pick station control circuit 220 and/or the PP control circuit 102 can provide identifying information of a product and/or package and instructions for the incorporation of the product into the package. These instructions can include graphical representations, animation, text, and/or other relevant information. For example, the display can illustrate a graphical representation of the pick station from the view of the worker, illustrate, highlight and/or otherwise distinguish the location of the relevant product 252 and/or container 254 from which a product is to be retrieved, and further illustrate, highlight or otherwise distinguish a package 250 into which one or more products are to be placed. Further, system conditions and/or errors may be detected and presented to the worker (e.g., detect placement of a product into an incorrect package, invalid movement of a package or product, system issues, and/or other errors or conditions). Similarly, the user interface may provide information and/or feedback to the worker such as product and/or package queue information, rate of packaging, capacity information, expectations, and/or substantially any relevant information. Typically, the worker and/or automated system scans a product as it is cooperated with the package 250, and/or scanning systems are positioned to automatically capture identifying information of the retrieved product 252 and/or the package 250 into which the product is placed. This enables the system to confirm accurate packaging of the intended product 252 with the intended package 250. Again, in some embodiments, the worker can be notified of potential errors through the user interface or other system (e.g., personal device, visual indicators, audible indicators, etc.).

In some embodiments, the pick station 112 further includes one or more package buffer stations 208 that are each configured to receive and temporarily hold or partially hold one or more queued packages 250 that were previously retrieved and transported to the pick station 112 and staged, and from which buffered packages 250 are subsequently retrieved in response to a product 252 of an order with which the respective buffered package is available at the respective pick station 112. The pick station control circuit 220, in some embodiments, is configured to control the movement of the buffered packages 250 at the respective pick station 112 to transition packages between the package buffer stations 208 and the packing positions 204. This can include moving packages from the package buffer stations to a packing position, and/or from a packing position to a package buffer station. In some implementations, the pick station 112 can include one or more package transfer systems 206 that cooperatively operate with the package buffer stations 208, the one or more package inputs to the pick station (e.g., package routing system 111, hand delivery, robotic retrieval, etc.) and the packing positions 204. Similarly, the pick station 112 can include one or more product transfer systems 214 that cooperatively operate with the product buffer stations 216, the one or more product inputs to the pick station (e.g., the PR system 108, hand delivery, robotic delivery, etc.) and the packing positions 204. Further, in some embodiments, the package transfer system 206 can cooperatively operate with transfer systems exterior of the pick station 112, such as receiving packages, transporting packed packages away from the pick station, and/or other such transport systems. In some embodiments, the package transfer system 206 is configured to automate the movement of the respective queued packages 250 between one or more packing positions 204 and the package buffer stations 208 of the respective pick station 112 in response to an instruction from the pick station control circuit 220 and/or the PP control circuit 102.

In some implementations, the pick station 112 includes multiple package buffer stations 208 enabling multiple different packages for one or more different orders to be staged at the pick station 112 while awaiting products to be received at the pick station 112. Further, the package buffer stations 208 enable packages to be moved into and out of the package buffer stations to enhance the rate of packaging throughput of the pick station, improve packaging efficiency, enhance accuracy of packaging, and other such benefits. In some embodiments, the pick station control circuit is configured to initiate instructions to control the package transfer system 206 to automate the movement of the respective queued packages 250 between one or more packing positions 204, one or more package inputs to the pick station (e.g., the package routing system 111) and the package buffer stations 208. This control can be based on the determination that products are at the pick stations corresponding to a package at the pick station, not all products to be packaged are available at the pick station, delays in transporting products and/or packages have occurred, and/or other such instances. In some embodiments, for example, pick station control circuit 220 can control the movement of the packages at the respective pick station to transition a partially loaded package associated with a particular order to one of the package buffer stations 208 until an additional product for the particular order is subsequently received at the pick station 112. In some instances, the pick station control circuit 220 and/or the PP control circuit 102 can utilize the tracking information and based on the tracking determine that corresponding one or more products of a particular order associated with one or more respective queued package are predicted to be available to be packaged with the respective one or more queued package, and instruct the package transfer system 206 to move the respective one or more queued packages between the packing position 204 and the package buffer stations 208. For example, the PP control circuit 102, based on the tracking, can identify when the corresponding products of a particular order to be packaged within a respective queued and/or buffered package are available to be packaged, and control the package transfer system 206 (e.g., through the pick station control circuit 220 when included) to move the respective queued package into a packing position 204.

In some implementations, the pick station 112 includes the multiple product buffer stations 216 enabling multiple different products for one or more different orders to be staged at the pick station 112 while awaiting packages to be received at the pick station 112. Further, the product buffer stations 216 enable products to be moved into and out of the product buffer stations to enhance the rate of packaging throughput of the pick station, improve packaging efficiency, enhance accuracy of packaging, and other such benefits. In some embodiments, the pick station control circuit is configured to initiate instructions to control the product transfer system 214 to automate the movement of the respective queued products 252 between one or more packing positions 204, the one or more product inputs to the pick station (e.g., the PR system 108) and the product buffer stations 216. This control can be based on the determination that products are at the pick stations corresponding to a package at the pick station, not all products to be packaged are available the pick station, delays in transporting products and/or packages have occurred, and/or other such instances. In some embodiments, for example, pick station control circuit 220 can control the movement of the products at the respective pick station to transition a product 252 and/or container 254 that is to be retained at the pick station to one of the product buffer stations 216 until a package for the particular order is subsequently received at the pick station 112. As described above, the containers 254 can be of a single size or a variety of sizes. Further, the container may include on a single product or multiple products. Additionally, when housing multiple products, some embodiments allow different types of products to be retained within a single container 254. The identifications of products and the corresponding container into which they are positioned enables the inventory system 120 to track the products location to enable the retrieval and routing of the products as need through the order packing control system 100, a fulfillment system in which the order packing control system 100 is apart, the facility, multiple facilities and the like. In some instances, the pick station control circuit 220 and/or the PP control circuit 102 can utilize the tracking information and based on the tracking determine that corresponding one or more packages 250 of a particular order associated with one or more respective queued products 252 are predicted to be available to be packaged, and instruct the product transfer system 214 to move the respective one or more queued products between one or more packing positions 204 and one or more of the product buffer stations 216. For example, the PP control circuit 102, based on the tracking, can identify when the corresponding package of a particular order to be receive a respective one or more queued and/or buffered products is available, and control the product transfer system 214 (e.g., through the pick station control circuit 220 when included) to move the respective queued products into a packing position 204.

In some embodiments, the PP control circuit, in controlling the synchronization of the PR system and the CPF system in some embodiments, schedules the queuing over time of the multiple different queued packages in utilizing the package buffer stations 208 in synchronizing the availability of the fabricated packages 250 and the products 252 at the respective pick stations 112. Further, in some implementations, a partially loaded package 250 may be moved out of the pick station 112 to a temporary holding area, bin, rack, shelf or the like to await further incorporation of products. Further, in some implementations, the PP control circuit 102 directs the movement of a partially loaded package to a loading or staging area where it is prepared to be transferred to a different facility where one or more further products can be incorporated into the partially loaded package.

Further, in some embodiments, one or more of the pick stations can comprise product buffer stations 216 that are configured to receive and temporarily hold one or more and often multiple different queued products 252. These products can be buffered in the product buffer stations 216 while the other products continue to be delivered to the respective pick station 112 and packaged with the other packages 250. In some embodiments, the multiple different queued products 252 can be temporarily held in the product buffer stations 216 in accordance with the station package queue as a function of the synchronized control of the PR system 108 and the CPF system 110 in positioning the respective queued products to be available when the one or more packages 250 associated with one of the orders are available at the respective pick station 112 to receive one or more of the queued products 252. Again, the PP control circuit 102 and/or the pick station control circuit 220 can use sensor data to track conditions, states of operation, states of package fabrication, and/or states of movement of products and/or packages in determining the scheduling and/or predicting timing to control the retrieval and movement of products to coincide with the fabrication and/or retrieval of packages to that one or more products of an order are available the pick station within a threshold time of a corresponding package of the order is available at the ick station.

The product buffer stations 216 and/or package buffer stations 208 enable differences in time as to when a product of an order is initially available at the pick station relative to when a corresponding package of the order is available at the pick station. This buffering greatly increases the throughput of packaging of products, in part, because retrieval and/or fabrication of products and/or packages can be simplified and enable the packing positions to be substantially continuously utilized to pack products instead of having to wait for products or packages. Similarly, the use of the buffering can be used in defining product retrieval scheduling and/or the package fabrication. For example, the PP control circuit 102 can detect that two orders request the same product. Accordingly, when retrieving that product for one order the product can similarly be retrieved at that time and buffered even though other products of the second order may not yet be available for packaging. The PP control circuit, in controlling the synchronization of the PR system 108 and/or the CPF system 110, can schedule the queuing over time of the multiple different products 252 in utilizing the product buffer stations in synchronizing the availability of the queued products and the fabricated packages at the respective pick stations. Additionally, the buffering enables the partially loading of a package then buffering to free up the packing position 204. When additional products are available for packaging for the partially loaded package, the partially loaded package can be retrieved from the package buffer station and positioned in the packing position to receive further products.

In some embodiments, the PP control circuit 102 implements a buffering control application in assigning products and/or packages to pick stations 112 and/or in controlling the buffering of products and/or packages. The buffering control application can access inventory information about inventory quantities and locations of available products and the fabrication schedule defining the schedule and expected timing of when respective custom packages are to be fabricated and available for use and/or when pre-fabricated packages are available for use. In some implementations, the buffering control application considers an order queue of the multiple pending product orders for each of the pick stations defining a sequence of multiple orders previously assigned to each of the pick stations and predicted durations to complete the packaging of the respective sequence of multiple orders at the respective pick stations. The PP control circuit in applying the buffering control application, in some embodiments, is configured to utilize the order prioritization in relation to product inventory information to predict a duration to retrieve a set of one or more products of a particular product order to be delivered to one of the pick stations selected to at least partially fulfill the particular product order. The application can further include the prediction of a package availability time, as a function of the fabrication schedule, that a particular package associated with the particular product order is to be available to be delivered to the selected pick station.

The PP control circuit 102, in some embodiments, adjusts at least one of a product retrieval schedule and the fabrication schedule to provide the particular package to the selected pick station within a threshold buffer period of time of a predicted product availability time of when each of the first set of products of the particular is to be available at the selected pick station. In some implementations, the PP control circuit applying a buffering control application further estimates a time difference between the predicted product availability time and the package availability time. A package buffer station 208 can be assigned as a function of the estimated time difference to ensure the package is available at the pick station 112 at the product availability time.

As described above, the order packing control system 100 in some embodiments enables partial fulfillment of an order, and then forwarding the partially loaded package to a temporary storage location, a different pick station 112, a different fulfillment facility and/or other such transfers to complete the fulfillment. In some embodiments, the PP control circuit 102 is further configured to control the PR system 108 in response to a notification from a pick station 112 that a package is ready for transport and further identify that the package is associated with a particular order that includes an additional product to be added to the package at a different facility. Based on the identification that the package is to be transferred, the PP control circuit can control the package routing system 111, the PR system 108 and/or other relevant transport to transport the partially loaded package from the pick station to a storage location (e.g., storage location of the PR system 108, storage location in a pre-shipping area, storage location in a transport vehicle, etc.) in preparation for shipping the package. In some instances, the partially loaded package is moved to a storage location in preparation for cooperating the partially loaded package with one or more other partially loaded packages to be routed to the different facility. For example, multiple partially loaded packages intended for a separate fulfillment facility can be secured together on a pallet, which may include fully loaded packages and/or products intended for the separate fulfillment facility, loaded into a vehicle and transported to the separate facility.

Similarly, in some embodiments, the order packing control system 100 can be the recipient of a partially loaded package with the intention that the order packing control system 100 load one or more additional products into the partially loaded package and/or complete the loading of the package. The PP control circuit can further be configured to identify, in adding one or more products to and/or completing a packaging of a particular incomplete order, that corresponding package was previously added to the PR system 108 and/or the CPF system in a partially loaded state with one or more previously loaded products. The PR system 108 and/or CPF system 110 is controlled by the PP control circuit 102, as part of the adding to or completing the packaging of the particular incomplete order, as a function of the order prioritization and the orders scheduled to be completed at one or more pick stations to retrieve the partially loaded package from a storage location of the PR system and route the partially loaded package to the assigned pick station. The PR system 108 is further controlled to retrieve one or more additional products and route the one or more additional products to the assigned pick station to synchronize, within an availability threshold of time, the availability of the one or more additional products at the assigned pick station and the availability of the partially loaded package at the same assigned pick station.

In some embodiments, the order packaging control system 100 is incorporated with a multi-phase fulfillment system and/or process that provides for the in-take of products, and the use of those products in fulfilling and/or partially fulfilling orders. The multi-phase fulfillment system, in some implementations, utilizes the PR system 108 as part of the in-take process in moving products into the facility and temporarily storing products for subsequent retrieval for fulfillment at the pick stations 112 and/or other aspects of the multi-phase fulfillment system and/or facility. Additionally, this multi-phase fulfillment system can fulfill orders leveraging CPF system machine in cooperation with one or more packaging areas through one or more pick stations. In some embodiments, custom packages are provided through the CPF system 110 and provided to assigned pick stations. Some embodiments sequence packages through the PR system 108 and/or a package routing system 111. Similarly, the PP control circuit synchronizes the retrieval and routing of products through the PR system 108 to provide products at the assigned pick station where the corresponding package is routed and at least part of the order is to be fulfilled. In some embodiments, the PR system 108 holds some of the products of the inventory in the form of individual items, eaches or cartons in varying sized containers that are routed as part of the in-take or inbound process into storage locations in the SR system. At the pick stations, a worker and/or automated pick system retrieves the one or more products and inserts, loads and/or otherwise appropriately cooperates the one or more products with the intended package.

In some embodiments, one or more packages and/or products can be buffered in the respective package buffer and product buffer of the pick station to enable at least enhanced throughput. Some embodiments additionally or alternatively provide buffering of loaded and/or partially loaded packages within the PR system 108 to time the package for pick up, pick additional products into this package, and/or route the package to another location and/or facility to incorporate one or more additional products.

In some embodiments, the CPF system 110 and/or the PP control circuit 102 execute cartonization logic using at least in part dimensions of the one or more products, and typically additional one or more other order characteristics to define the type and dimensions of the one or more custom packages to be created specifically for this customer order and/or to select one or ore pre-fabricated packaging for the order. The PP control circuit 102 creates and manages a queue of orders based on one or more factors such as but not limited to a specified and/or requested order completion time or cut-off time, order priority, improved or optimal process path (e.g., routing, retrieving products, which pick station, etc.) and the capacity for each process path. Based on these aspects, the PP control circuit provides instructions to the PR system, CPF system and relevant one or more picks station 112 (e.g., a single order may be partially fulfilled at two or more different pick stations) to implement the fulfillment for execution. The PR system, CPF system and pick stations operate to maintain a dynamic order queue based on the criteria defined by the PP control circuit, and execute based on that queue order relative to one or more thresholds and/or limits (e.g., a maximum capacity associated with or defined for one or more process paths). The PP control circuit coordinates the operation of the PR system and the CPF system to synchronize the availability of the products and packages at respective pick stations. Based on the order queue and synchronization, the CPF system 110 is activated to fabricate the custom rightsized package for the particular one or more products of the order, which is then conveyed and sequenced to a specific pick station 112 with the inventory containers 254 and/or products retrieved by the PR system 108 to the same station. The worker and/or automated system directly picks the relevant one or more products (e.g., from one or more inventory containers) and cooperated with the custom package.

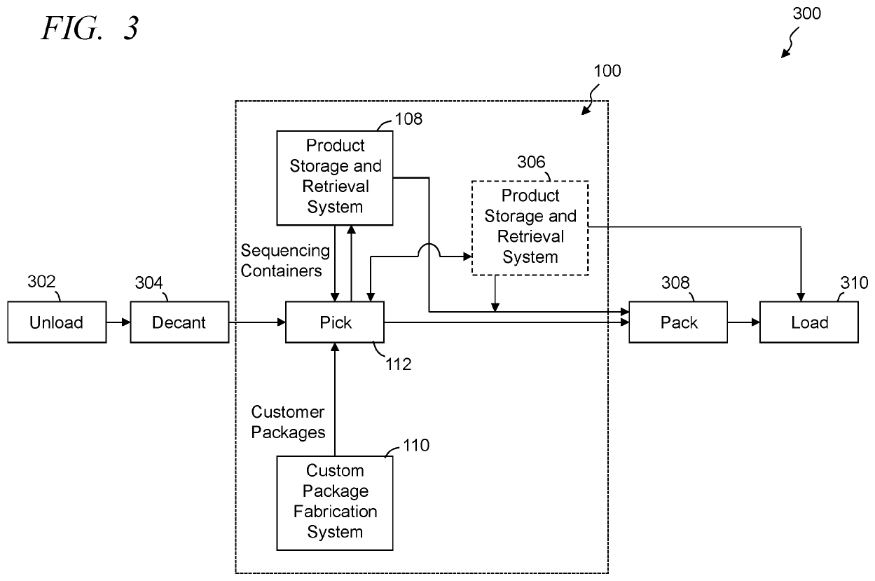

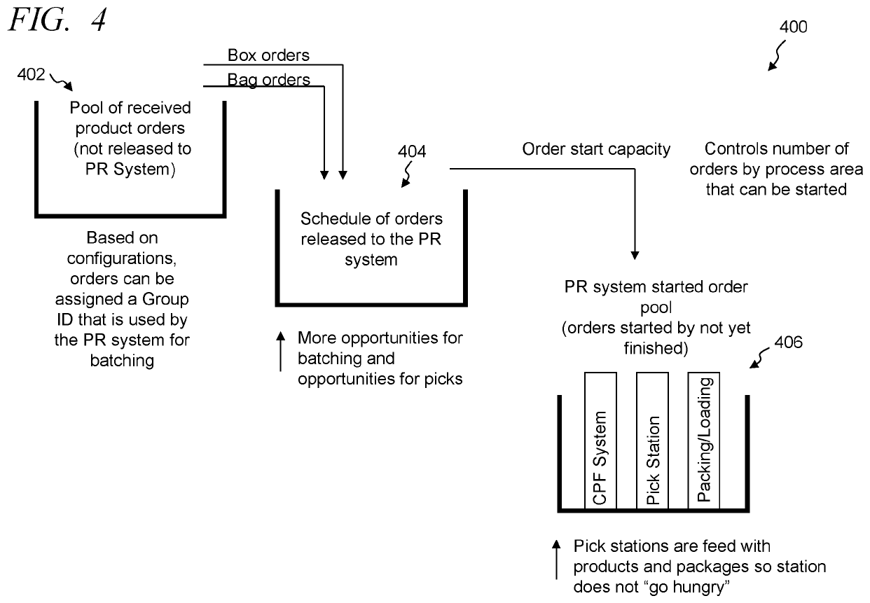

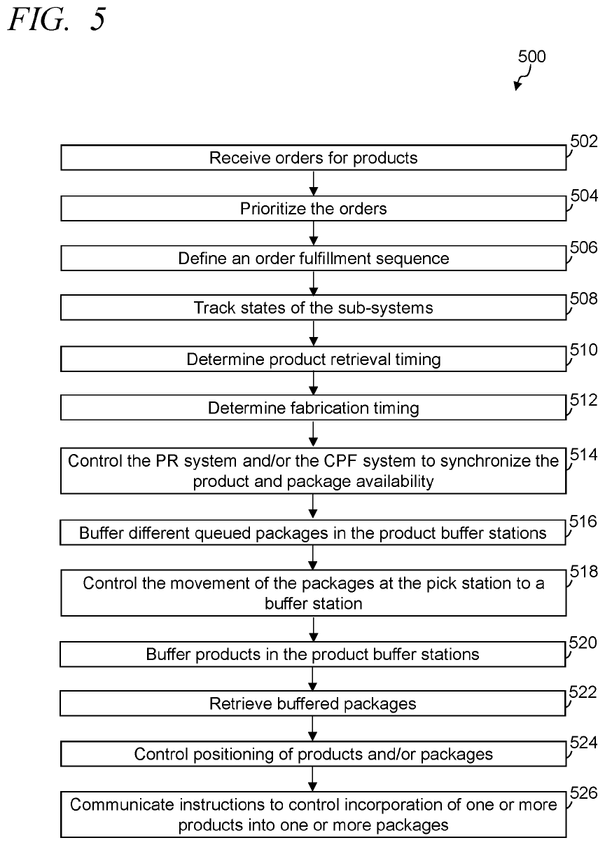

FIG. 3 illustrates a simplified functional block diagram of an exemplary multi-phase fulfillment system 300, in accordance with some embodiments. The multi-phase fulfillment system 300 includes, in some embodiments, an unload system 302 and/or phase, a decant system 304 and/or phase, the order packing control system 100, a pack system 308 and/or phase, and a load system 310 and/or phase. The unload system 302 and the decant system 304 operates as at least part of an in-take of products to the facility or facilities. For example, trucks and/or other delivery vehicles deliver inventory of products. These delivered products are unloaded from the vehicles. The unload system can include one or more systems such as but not limited to product scanners and/or identifier systems, transport systems (e.g., conveyors, forklifts, unmanned vehicles, pallet carts, etc.) that are used to move products from the vehicles to be decanted and/or stored.

The decant system 304 decants at least some of the products from collections of products into individual products and/or reduced numbers of products. It is very common for products to be delivered in a collection on a pallet. Accordingly, the decanting, in some implementation can include the un-palletizing of products. Further, it can be beneficial for at least some products to separate some groups of products (e.g., cases, boxes, etc.) into individual eaches or products. The decanting can include adding products into containers that are intended for temporary storage in the PR system 108. In some embodiments, the decanting system 304 can be implemented through the systems, methods and/or processes described in U.S. Patent Application Publication No. US20200306973, entitled INTEGRATED ITEM DECANTING SYSTEM, which is incorporated herein by reference in its entirety.

The order packing control system 100 can be implemented as described above. Again, in some embodiments as described above, the order packing control system 100 can optionally further temporarily store partially loaded package for later retrieval for further loading, and/or for subsequent transport to another location and/or facility to enable further loading of one or more products. The temporary storing or buffering of the partially loaded package can be provided in some embodiments through the PR system 108. In some embodiments, the order packing control system 100 can optionally include and/or cooperatively operate with one or more optional additional temporary load storage 306 that can receive and temporarily retain partially loaded packages received at the multi-phase fulfillment system 300 to be further loaded with one or more products through the multi-phase fulfillment system 300, and/or to temporarily retain partially loaded packages that are partially loaded through the order packaging control system 100 and intended to be transported to another location or facility.

In some embodiments, the pack system 308 and/or phase can be configured assemble multiple packages for loading into a vehicle. The assembly can include one or more of cooperating multiple packages (e.g., onto a pallet, into containers, etc.), organizing products according to a transport route and/or in association with an intended vehicle, putting packages onto transport systems and/or other such aspects to get packages ready for transport. The load system 310 can include one or more systems such as but not limited to product scanners and/or identifier systems, transport systems (e.g., conveyors, forklifts, unmanned vehicles, pallet carts, etc.) that are used to move products into the vehicles. Accordingly, the multi-phase fulfillment system 300 provides multiple systems and/or phases to in-take products, use those products in fulfilling and/or partially fulfilling orders, and initiating transport to an intended location (e.g., customer's delivery address, a retail facility, another fulfillment facility, etc.).

FIG. 4 illustrates a simplified functional representation of an exemplary process 400 of controlling the picking and packaging of products, in accordance with some embodiments. Orders are received 402, and pooled in preparation for scheduling the picking of the respective orders. Based on capacity, priorities and/or other factors, the orders are incorporated into the scheduled order queue 404. In some instances, different types of orders, expected packaging, type of customer receipt (e.g., pick-up versus pick-up at a different location versus delivery, etc.) may be distinguished. Based on capacities, inventory levels and/or other factors the orders are assigned 406 to the different pick stations for fulfillment or partial fulfillment.

FIG. 5 illustrates a simplified flow diagram of an exemplary process 500 of fulfilling product orders, in accordance with some embodiments. In step 502 orders for products from a retailer are received over time at a product packaging (PP) control circuit and from one or more product order systems. Each order is requesting one or more of products. In step 504, the orders are prioritized. In some instances, the priority is based in part on and/or determined as a function of the one or more products of each of the orders and inventory levels of those products.

In step 506, an order fulfillment sequence is defined based on the order prioritization. In step 508, states of the PR system 108 and the CPF system 110 are tracked. This tracking, in some embodiments, can at least in part be based on sensor data received from a set of sensor systems configured to detect positions of custom packages and products as they are transported to and from pick stations. In step 510, product retrieval timing is determined of when the one or more products for each of the orders is to be retrieved as a function of the order prioritization.

In step 512, fabrication timing is determined for when the CPF system 110 is to fabricate corresponding packaging as a function of a package fabrication queue. In step 514, both of the PR system 108 and the CPF system 110 are cooperatively controlled in controlling synchronous operation of the PR system and the CPF system. In some embodiments, the control determined as a function of the tracking and order prioritization, to synchronize the availability of the one or more products of an order of the orders at a particular pick station 112 of the pick stations and the availability of a corresponding particular custom package at the particular pick station.

Some embodiments include step 516 to buffer and temporarily hold different queued packages 250 at each of the pick stations 112 while other packages continue to be delivered to the respective pick station and one or more other products 252 are packaged with each of the other packages. The buffering, in some implementations, comprises temporarily holding the multiple different queued packages at the respective pick station in accordance with a station package queue as a function of the synchronized control of the PR system 108 and the CPF system 110 in positioning the respective queued packages to be available when the one or more products of a respective one of the orders are available to be packaged in a respective one of the queued packages. In some embodiments, the control of buffering can include estimating a time difference between the predicted product availability time and package availability time of an intended package corresponding to the order, and assigning a first package buffer station 208 as a function of the estimated time difference to ensure the intended package is available at the pick station 112 at the product availability time. Some embodiments predict, based on the tracking, that one or more of the corresponding products 252 of the order associated with the respective queued package 250 are predicted to be available at the pick station 112 to be packaged with the respective queued package. Based on this predicted availability of the corresponding one or more products of the order, a package transfer system 206 of the pick station can be controlled in some embodiments in automating the movement of the respective queued packages 250 between one or more packing positions 204 and the package buffer stations 208 and/or the input to the pick stations (e.g., package routing system 111). Similarly, some embodiments predict, based on the tracking, that a corresponding package 250 of the order associated with one or more queued products 252 is predicted to be available at the pick station 112. Based on this predicted availability of the corresponding package of the order, a product transfer system 214 of the pick station 112 can be controlled in some embodiments in automating the movement of the respective one or more products 252 between one or more packing positions 204 and one or more product buffer stations 216 and/or the product input to the pick stations (e.g., the PR system 108).

Step 518 is included in some embodiments where movement of the packages at the respective pick station 112 is controlled by a pick station control circuit 220 of the respective pick station 112 and/or the PP control circuit 102 to transition a partially loaded package associated with a particular order to one of the package buffer stations 208 until an additional product for the particular order is subsequently received at the respective pick station 112. Such a package buffering of a partially loaded pack can be implemented because one or more products of the order is scheduled to be at the pick station to enable further fulfillment of the order, one or more higher priority orders are to be performed before continuing the fulfillment of the particular buffered order, an insufficient quantity of a product is available at the pick station, and/or other such conditions.

In step 520, one or more of multiple different queued products are received and temporarily held in respective product buffer stations 216 of the pick stations 112 while other products continue to be delivered to the respective pick station and packaged with other packages. The product buffering and temporarily holding of products is controlled, in some embodiments, in accordance with the station package queue as a function of the synchronized control of the PR system 108 and/or the CPF system 110 in positioning the respective queued products to be available when the one or more packages associated with one of the orders are available at the respective pick station to receive respective one or more of the queued products.

In step 522, one or more buffered packages being temporarily held in one or more of the package buffer stations are retrieved from one or more of the package buffer stations 208 in response to one or more products 252 of an order with which the respective buffered package corresponds are available at the respective pick station. In step 524, one or more products 252 for a particular order are positioned at a one or more packing positions 204, and/or one or more packages 250 for that particular order are positioned at one or more of the packing positions 204. In step 526, instructions are provided to incorporate products into retrieved package and to control the packing of the one or more products into the respective one or more packages in at least partially fulfilling the particular order. The positioning of products can include retrieval of one or more buffered products 252 that are being temporarily held in one or more of the product buffer stations 216 from one or more of the product buffer stations in response to one or more packages 250 of an order with which the respective buffered product corresponds are available at the respective pick station 112. Similarly, the positioning of packages 250 can include retrieval of one or more buffered packages that are being temporarily held in one or more of the package buffer stations 208 from one or more of the package buffer stations in response to one or more products 252 of an order with which the respective buffered package corresponds are available at the respective pick station 112. One or more of the above steps and/or the process can be repeated one or more times. Further, the steps may similarly be performed in varying orders, and/or repeated one or more times prior to advance to another step. Additionally, one or more steps may be performed simultaneously.

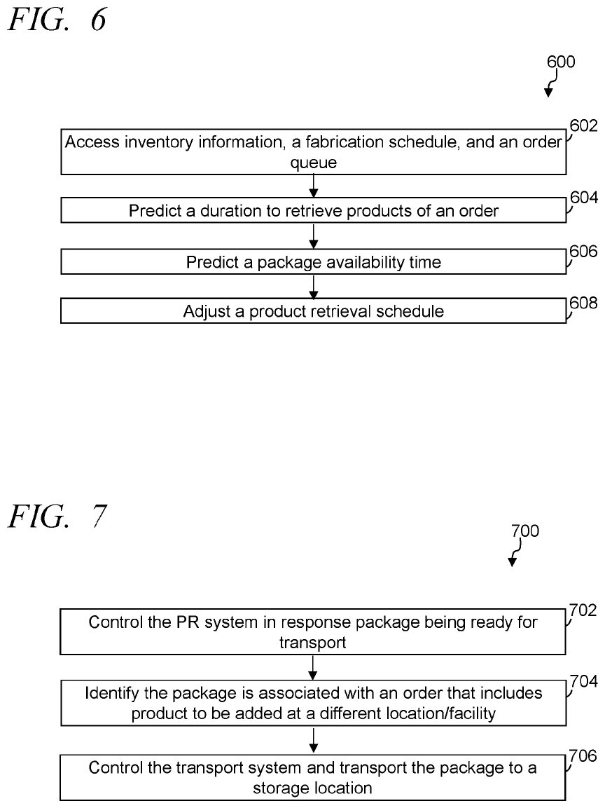

FIG. 6 illustrates a simplified flow diagram of an exemplary process 600 of controlling retrieval of product and package fabrication and/or retrieval of pre-fabricated packages. In step 602, inventory information is accessed about inventory quantities and locations of available products 252. Some embodiments access one or more fabrication schedules defining a schedule and expected timing of when respective custom packages are to be fabricated and/or retrieved and available for use. One or more order queue for each of the pick stations 112 can be accessed that define a sequence of multiple orders previously assigned to each of the pick stations and predicted durations to complete the packaging of the respective sequence of multiple orders.

In step 604, a duration predicted, utilizing the order prioritization in relation to product inventory information, to retrieve a set of one or more products of a particular order to be delivered to an assigned pick station. In step 606, a first package availability time is predicted, as a function of the fabrication schedule, that an assigned package is to be available to be delivered to the assigned pick station. In step 608, one or both of a product retrieval schedule and the fabrication schedule can be adjusted to provide the particular package to the assigned pick station within a threshold buffer period of time of a predicted product availability time of when each of the set of one or more products of the particular order is to be available at the assigned pick station. One or more of the above steps and/or the process can be repeated one or more times. Further, the steps may similarly be performed in varying orders, and/or repeated one or more times prior to advance to another step. Additionally, one or more steps may be performed simultaneously.

FIG. 7 illustrates a simplified flow diagram of an exemplary process 700 of controlling the loading of a package 250, in accordance with some embodiments. As described above, it can be beneficial to partially loaded a package. For example, a package can be partially loaded with one or more products in preparing that package for subsequent packaging at different location, prior to buffering the package while freeing up a packing position to improve throughput, and/or other reasons. In step 702, the PR system is controlled in response to a notification from an assigned pick station that a particular package is ready for transport away from the pick station (e.g., the one products scheduled to be loaded have been loaded). In step 704, the PP control circuit 102 can identify that the particular package is associated with an order that is not completely fulfilled and one or more additional products are to be subsequent added to the particular package, that the particular package is associated with an additional order that includes an additional product to be added to the particular package at a different location and/or facility, or other identification that the package is not fully loaded.

In step 706, the package routing system 111 is controlled to transport the partially loaded package from the pick station to a storage location of the PR system 108 in preparation for preparing the partially loaded package for transport to a different location, cooperating the partially loaded package with one or more other partially loaded packages to be routed to the different facility, and/or other such subsequent actions in completing the loading of the particular package relative to the corresponding order. One or more of the above steps and/or the process can be repeated one or more times. Further, the steps may similarly be performed in varying orders, and/or repeated one or more times prior to advance to another step. Additionally, one or more steps may be performed simultaneously.

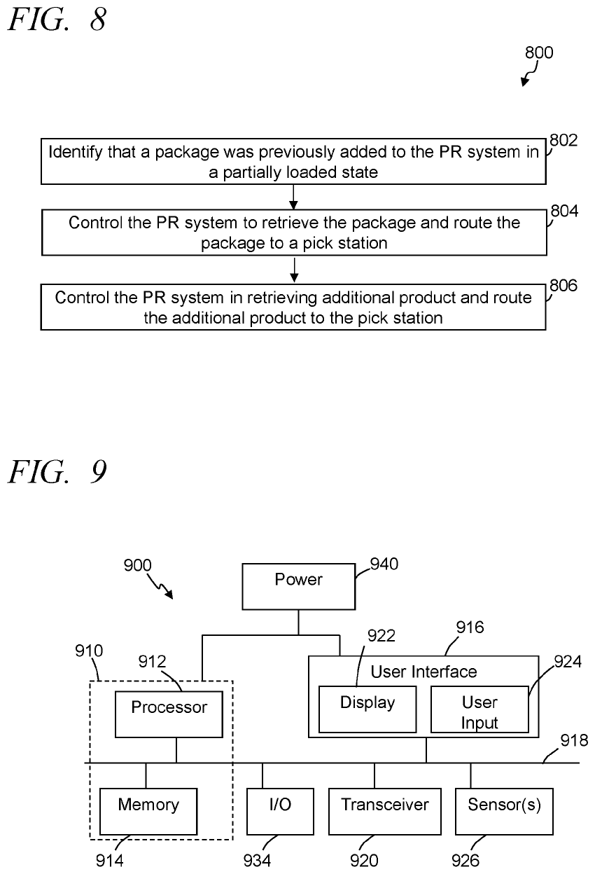

FIG. 8 illustrates a simplified flow diagram of an exemplary process 800 of completing a loading of a particular package and/or completing a packaging of an order into a partially loaded package, in accordance with some embodiments. In step 802, the PP control circuit 102 identifies, in completing a loading of the package and/or the completing the packaging of an incomplete order, that a particular package was previously added to the PR system 108 in a partially loaded state with one or more previously loaded products.

In step 804, the PR system 108 is controlled, in completing the loading of the partially loaded package and/or the incomplete order as a function of the order prioritization and the orders scheduled, to retrieve the partially loaded package from a storage location of the PR system and route the partially loaded package to an assigned pick station 112. In step 806, the PR system 108 is controlled to retrieve one or more additional products and route the one or more additional products to the assigned pick station to synchronize, within an availability threshold of time, the availability of the one or more additional products at the assigned pick station and the availability of the partially loaded package at the assigned pick station. One or more of the above steps and/or the process can be repeated one or more times. Further, the steps may similarly be performed in varying orders, and/or repeated one or more times prior to advance to another step. Additionally, one or more steps may be performed simultaneously.

Further, the circuits, circuitry, systems, devices, processes, methods, techniques, functionality, services, servers, sources and the like described herein may be utilized, implemented and/or run on many different types of devices and/or systems. FIG. 9 illustrates an exemplary system 900 that may be used for implementing any of the components, circuits, circuitry, systems, functionality, apparatuses, processes, or devices of order packaging control system 100, and/or other above or below mentioned systems or devices, or parts of such circuits, circuitry, functionality, systems, apparatuses, processes, or devices. For example, the system 900 may be used to implement some or all of PP control circuit 102, inventory retaining system 106, PR system 108, CPF system 110, package routing system 111, pick stations 112, sensor systems a14, inventory system 120, product in-take system 122, product order system 124, package finishing system 128, package transfer system 206, product transfer system 214, pick station control circuit 220, pick station user interface 222, and/or other such components, circuitry, functionality and/or devices. However, the use of the system 900 or any portion thereof is certainly not required.

By way of example, the system 900 may comprise a control circuit or processor module 912, memory 914, and one or more communication links, paths, buses or the like 918. Some embodiments may include one or more user interfaces 916, and/or one or more internal and/or external power sources or supplies 940. The control circuit 912 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 912 can be part of control circuitry and/or a control system 910, which may be implemented through one or more processors with access to one or more memory 914 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 900 may be used to implement one or more of the above or below, or parts of, components, circuits, systems, processes and the like.

The user interface 916 can allow a user to interact with the system 900 and receive information through the system. In some instances, the user interface 916 includes a display 922 and/or one or more user inputs 924, such as buttons, touch screen, track ball, keyboard, mouse, etc., which can be part of or wired or wirelessly coupled with the system 900. Typically, the system 900 further includes one or more communication interfaces, ports, transceivers 920 and the like allowing the system 900 to communicate over a communication bus, a distributed computer and/or communication network 104 (e.g., a local area network (LAN), the Internet, wide area network (WAN), etc.), communication link 918, other networks or communication channels with other devices and/or other such communications or combination of two or more of such communication methods. Further the transceiver 920 can be configured for wired, wireless, optical, fiber optical cable, satellite, or other such communication configurations or combinations of two or more of such communications. Some embodiments include one or more input/output (I/O) ports 934 that allow one or more devices to couple with the system 900. The I/O ports can be substantially any relevant port or combinations of ports, such as but not limited to USB, Ethernet, or other such ports. The I/O interface 934 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 926 to provide information to the system and/or sensor information that is communicated to another component. The sensors can include substantially any relevant sensor, such as distance measurement sensors (e.g., optical units, sound/ultrasound units, etc.), optical-based scanning sensors to sense and read optical patterns (e.g., bar codes), radio frequency identification (RFID) tag reader sensors capable of reading RFID tags in proximity to the sensor, cameras, weight sensors, location sensors, and/or other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 900 comprises an example of a control and/or processor-based system with the control circuit 912. Again, the control circuit 912 can be implemented through one or more processors, controllers, central processing units, logic, software and the like. Further, in some implementations the control circuit 912 may provide multiprocessor functionality.

The memory 914, which can be accessed by the control circuit 912, typically includes one or more processor-readable and/or computer-readable media accessed by at least the control circuit 912, and can include volatile and/or nonvolatile media, such as RAM, ROM, EEPROM, flash memory and/or other memory technology. Further, the memory 914 is shown as internal to the control system 910; however, the memory 914 can be internal, external or a combination of internal and external memory. Similarly, some or all of the memory 914 can be internal, external or a combination of internal and external memory of the control circuit 912. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network 104. The memory 914 can store code, software, executables, scripts, data, content, lists, programming, programs, log or history data, user information, customer information, product information, and the like. While FIG. 9 illustrates the various components being coupled together via a bus, it is understood that the various components may actually be coupled to the control circuit and/or one or more other components directly.

Some embodiments provide order packaging control systems, comprising: a product packaging (PP) control circuit comprising at least one processor and memory communicatively coupled with the processor, the PP control circuit configured to communicatively couple over one or more distributed communication networks with: an automated custom package fabrication (CPF) system configured to fabricate on demand custom packages according to custom sizing as a function of one or more products intended to be shipped; an automated product retrieval (PR) system configured to autonomously retrieve one or more products of orders being received over time; pick stations cooperated with the CPF system and the PR system; and a set of sensor systems configured to detect positions of custom packages and products as they are transported to and from the pick stations; wherein the PP control circuit is configured to: receive over time, from one or more product order systems, the orders; prioritize the orders as a function of the one or more products of each of the orders and inventory levels, and define an order fulfillment sequence based on the order prioritization; track, based on sensor data, states of the PR system and the CPF system and determine product retrieval timing of when the one or more products for each of the orders is to be retrieved as a function of the order prioritization, and correspondingly determine fabrication timing of when the CPF system is to fabricate corresponding packaging as a function of a package fabrication queue; control both the PR system and the CPF system in controlling the synchronous operation of the PR system and the CPF system, as a function of the tracking and order prioritization, to synchronize the availability of the one or more products of a first order of the orders at a first pick station of the pick stations and the availability of a first custom package at the first pick station.

In some embodiments, methods are provided for fulfilling product orders, the method comprising: receiving over time, at a product packaging (PP) control circuit and from one or more product order systems, orders for products from a retailer, wherein each order is requesting one or more of the products, wherein the PP control circuit is configured to communicatively couple over one or more distributed communication networks with an automated custom package fabrication (CPF) system configured to fabricate on demand custom packages according to custom sizing as a function of one or more products intended to be shipped, and an automated product retrieval (PR) system configured to autonomously retrieve one or more products of orders being received over time; prioritizing the orders as a function of the one or more products of each of the orders and inventory levels, and defining an order fulfillment sequence based on the order prioritization; tracking, based on sensor data received from a set of sensor systems configured to detect positions of custom packages and products as they are transported to and from pick stations, states of the PR system and the CPF system and determining product retrieval timing of when the one or more products for each of the orders is to be retrieved as a function of the order prioritization, and correspondingly determining fabrication timing of when the CPF system is to fabricate corresponding packaging as a function of a package fabrication queue; controlling both the PR system and the CPF system in controlling synchronous operation of the PR system and the CPF system, as a function of the tracking and order prioritization, to synchronize the availability of the one or more products of a first order of the orders at a first pick station of the pick stations and the availability of a first custom package at the first pick station.

The order packaging control system 100 reduces the number of processing time and/or manual touches of products that are to perform in implementing fulfillment functions of outbound product packaging. Similarly, the order packaging control system 100 when incorporated with an in-take or inbound and outbound fulfillment system. Some embodiments utilize a PR system 108 for storage and inventory of at least some of the products used in at least partially fulfilling orders. The PR system 108 is configured to hold numerous different types of products, and substantially all products that have dimensions consistent with interior dimensions of at least one of various different sized containers 254 and meet weight thresholds.

Based on the orders, the PP control circuit 102 and/or the CPF system 110 determine interior dimensions of one or more packages for one or more products of the orders. In some embodiments, the PP control circuit 102 and/or the CPF system 110 execute a cartonization logic, pool orders then release the orders to the PR system 108 and/or CPF system. The schedule of release of the product orders for fulfillment can be dependent on one or more factors. Some embodiments utilize a cut-off time of an order and/or one or more products, one or more priorities associated with an order, a capacity of the order packaging control system 100, pick stations, PR system and/or by area of the facility or facilities. In some embodiments, the order packaging control system 100 can extend to multiple facilities at one or multiple locations. Similarly, in some embodiments, the PP control circuit is implemented through multiple processor and/or servers geographically distributed and can cooperatively control multiple PR systems, CPF systems 100, pick stations 112 and other sub-systems of the order packaging control system 100 in fulfilling orders. This can enable the distribution of fulfillment of orders to facilities having the respective products and/or in attempts to optimize throughput by balancing load and demand across the multiple different facilities.

In some embodiments, order packaging control system 100 implements box-first approach with one or more products of an order being discretely picked directly into a right-sized box at the pick station 112. The determination of an accurate sizing of the package is performed, in some implementations applying a cubing algorithm as described above, which defines the dimensions of the package (e.g., box, bag, envelope, pouch, etc.) for a custom package building machine to create and/or the retrieval of a pre-fabricated package. In some embodiments, the cubing algorithm further identifies protective packaging and/or dunnage that is to be used in determining an appropriate package size. In other embodiments, the protective packaging is determined by a separate application, and the protective packaging is incorporated into the dimensions of the one or more products when performing the determining of a package size. In some embodiments, a labeling system, which may be part of or separate from the CPF system applies an identifier to the package that associates the package to the corresponding order. As one non-limiting example, the CPF system 100 can be configured to generates the package and auto-apply an identifying code (e.g., string alphanumeric characters, bar code, QR code, RFID tag, etc.) at one or more locations on or in the package right to identify the associated order intended for that package and/or provide a unique identifier for the package with the package identifier being associated with a particular order or orders that have been batched, grouped or otherwise associated. The package is conveyed to an assigned pick station 112.

The fulfillment facility can include one or more pick stations 112, and typically includes multiple pick stations. One or more of those pick stations can be staffed by one or more workers and/or include automated pick systems. Workers and/or pick systems are directed by the pick station control circuit 220 and/or the PP control circuit 102 in accurately retrieving specific products routed by the PR system 108 to the assigned pick station. In some embodiments, for example workers retrieve one or more specific products from a tote or other container 254 transported by the PR system.

At the pick station 112, the custom packages correspond to and/or represent unique customer orders or a grouping of customer orders. The PP control circuit 102 synchronized the routing of the products through the PR system and the packages through the CPF system 100 so that inventory for the order meet the correct target package at the assigned pick station, and typically meet within a predefined threshold. Some embodiments help to relax the complexity of the loading sequencing through the incorporation of product buffer stations 216 and/or package buffer stations 208. A pick station can include substantially any number and/or size of buffer stations. The sizes, however, are typically restricted to optimize use of the facility. As one non-limiting example, a pick station 112 can includes product buffer stations to hold two source containers 254 or totes, and package buffer stations to hold four packages at any one time. Once all units belong to an order have been picked out of their source totes and placed into their target package, the target package can be released and, in some instances, conveyed to package finishing. Some embodiments include one or more package finishing systems that receives outbound packages containing the products for that order, and incorporates protective packaging and/or seals the package, and in some instances applies labeling.

In some embodiments, the techniques described herein relate to an order packaging control system that can include one or more product packaging (PP) control circuits, one ore more automated custom package fabrication (CPF) systems, one or more automated product retrieval (PR) systems, one or more pick stations and one or more sets of sensor systems. The PP control circuit, in some embodiments includes at least one processor and memory communicatively coupled with the processor, and is configured to communicatively couple over one or more distributed communication networks with the one or more CPF systems that can be configured to fabricate on demand custom packages according to custom sizing as a function of one or more products intended to be shipped; the one or more PR systems that can be configured to autonomously retrieve one or more products of orders being received over time; the pick stations cooperated with at least one CPF system and at least one PR system; and at least one set of sensor systems configured to detect positions of custom packages and products as they are transported to and from the pick stations. Further, the PP control circuit can be configured to: receive over time, from one or more product order systems, the orders. The orders can be prioritized as a function of the one or more products of each of the orders and inventory levels, and an order fulfillment sequence defined based on the order prioritization. One or more states of the PR system and/or the CPF system can be tracked based on sensor data, and product retrieval timing can be determined of when the one or more products for each of the orders is to be retrieved as a function of the order prioritization. Correspondingly fabrication timing can be determined of when the CPF system is to fabricate corresponding packaging as a function of a package fabrication queue. One or more of the PR systems and/or one or more of the CPF systems can be controlled in controlling synchronous operation of the PR system and the CPF system, as a function of the tracking and order prioritization, to synchronize an availability of the one or more products of at least a first order of the orders at a first pick station of the pick stations and an availability of a first custom package at the first pick station.

In some embodiments one or more of the pick stations are each configured to buffer and temporarily hold different queued packages while other packages continue to be delivered to the respective pick station and one or more other products are packaged with each of the other packages. The different queued packages can be temporarily held at the respective pick station in accordance with a station package queue as a function of the synchronized control of the PR system and the CPF system in positioning the respective queued packages to be available when the one or more products of a respective one of the orders are available to be packaged in a respective one of the queued packages. One or more pick stations can be configured to include package buffer stations each configured to receive and temporarily hold at least one of the queued packages and from which buffered packages are subsequently retrieved in response to a product of an order with which the respective buffered package is available at the respective pick station. Additionally or alternatively, in some implementations, one or more of the pick stations can each include a pick station control circuit configured to control the movement of the packages at the respective pick station to transition a first partially loaded package associated with a first order to one of the package buffer stations until an additional product for the first order is subsequently received at the respective pick station.

Some embodiments can include one or more package transfer systems. For example, in some implementations one or more of the pick stations can include one or more package transfer systems that can be configured to automate the movement of the respective queued packages between one or more packing positions and one or more package buffer stations of the respective pick station. The movement can be controlled, in some implementations, based on and/or in response to an instruction from the pick station control circuit, which may be based on the tracking, that the corresponding one or more products of the order associated with the respective queued package are predicted to be available to be packaged with the respective queued package.

One or more of the pick stations, in some embodiments, can each include product buffer stations that can be configured to receive and temporarily hold multiple different queued products, while the other products continue to be delivered to the respective pick station and packaged with the other packages. The multiple different queued products can be temporarily held in the product buffer stations in accordance with the station package queue as a function of the synchronized control of the PR system and the CPF system in positioning the respective queued products to be available when the one or more packages associated with one of the orders are available at the respective pick station to receive respective one or more of the queued products. The PP control circuit can, in some embodiments, be configured to implement a buffering control application accessing inventory information about inventory quantities and locations of available products. Additionally or alternatively, in some implementations the PP control circuit can be configured to control and/or implement a fabrication schedule that can define a schedule and expected timing of when respective custom packages are to be fabricated and available for use. In some embodiments, the PP control circuit can implement at least one order queue for each of the pick stations defining a sequence of multiple orders previously assigned to each of the pick stations and predicted durations to complete the packaging of the respective sequence of multiple orders. In applying the buffering control application, the PP control circuit can be configured to: utilize the order prioritization in relation to product inventory information to predict a duration to retrieve a set of one or more products of a first order to be delivered to the first pick station; predict a first package availability time, as a function of the fabrication schedule, that the first package is to be available to be delivered to the first pick station, and adjust at least one of a product retrieval schedule and the fabrication schedule to provide the first package to the first pick station within a threshold buffer period of time of a predicted product availability time of when each of the first set of products of the first order is to be available at the first pick station. The buffering control application can further be configured, in some implementations, to estimate a time difference between the predicted product availability time and the first package availability time. A first package buffer station can be assigned as a function of the estimated time difference in attempts ensure the first package is available at the first pick station at the predicted product availability time.

In some embodiments, the PP control circuit can further be configured to control the PR system in response to a notification from the first pick station that a second package is ready for transport and further identify that the second package is associated with a second order that includes an additional product to be added to the second package at a different facility. A package routing system can be controlled to transport the second package from the first pick station to a storage location of the PR system in preparation for cooperating the second package with one or more other partially loaded packages to be routed to the different facility. The PP control circuit can, in some implementations, be further configured to: identify, in completing a packaging of a second order, that a second package was previously added to the PR system in a partially loaded state with one or more previously loaded products; and control the PR system, in completing the packaging of the second order, as a function of the order prioritization and the orders scheduled to be completed at the first pick station to: retrieve the second package from a storage location of the PR system and route the second package to the first pick station; and retrieve one or more additional products and route the one or more additional products to the first pick station to synchronize, within an availability threshold of time, the availability of the one or more additional products at the first pick station and the availability of the second package at the first pick station.

Some embodiments provide methods of fulfilling product orders comprising: receiving over time, at a product packaging (PP) control circuit and from one or more product order systems, orders for products from a retailer, wherein each order is requesting one or more of the products, wherein the PP control circuit is configured to communicatively couple over one or more distributed communication networks with an automated custom package fabrication (CPF) system configured to fabricate on demand custom packages according to custom sizing as a function of one or more products intended to be shipped, and an automated product retrieval (PR) system configured to autonomously retrieve one or more products of orders being received over time; prioritizing the orders as a function of the one or more products of each of the orders and inventory levels, and defining an order fulfillment sequence based on the order prioritization; tracking, based on sensor data received from a set of sensor systems configured to detect positions of custom packages and products as they are transported to and from pick stations, states of the PR system and the CPF system and determining product retrieval timing of when the one or more products for each of the orders is to be retrieved as a function of the order prioritization, and correspondingly determining fabrication timing of when the CPF system is to fabricate corresponding packaging as a function of a package fabrication queue; and controlling both the PR system and the CPF system in controlling synchronous operation of the PR system and the CPF system, as a function of the tracking and order prioritization, to synchronize an availability of the one or more products of a first order of the orders at a first pick station of the pick stations and an availability of a first custom package at the first pick station. Some embodiments buffer and temporarily hold different queued packages at each of the pick stations while other packages continue to be delivered to the respective pick station and one or more other products are packaged with each of the other packages. The buffering can include temporarily holding multiple different queued packages at the respective pick station in accordance with a station package queue as a function of the synchronized control of the PR system and the CPF system in positioning the respective queued packages to be available when the one or more products of a respective one of the orders are available to be packaged in a respective one of the queued packages.

The buffering, in some embodiments, can include temporarily holding at least one of the queued packages in one or more of package buffer stations of each of the pick stations, and subsequently retrieving buffered packages from the package buffer stations in response to a product of an order with which the respective buffered package corresponds is available at the respective pick station. Some embodiments can further control, by a pick station control circuit of a respective pick station, movement of the packages at the respective pick station to transition a first partially loaded package associated with a first order to one of the package buffer stations until an additional product for the first order is subsequently received at the respective pick station. One or more processes may further include: predicting, based on the tracking, that the corresponding products of the order associated with the respective queued package are predicted to be available to be packaged with the respective queued package; and controlling, based on the predicted availability of the corresponding products of the order, a package transfer system and automating the movement of the respective queued packages between one or more packing positions and the buffer stations of the respective pick station.

Some embodiments receive and temporarily hold, in one or more product buffer stations of the pick stations, one or more of multiple different queued products, while the other products continue to be delivered to the respective pick station and packaged with the other packages. The temporarily holding of the products can in some implementations include temporarily holding the multiple different queued products in accordance with the station package queue as a function of the synchronized control of the PR system and the CPF system in positioning the respective queued products to be available when the one or more packages associated with one of the orders are available at the respective pick station to receive respective one or more of the queued products. In some embodiments, one or more processes can include: accessing inventory information about inventory quantities and locations of available products, a fabrication schedule defining a schedule and expected timing of when respective custom packages are to be fabricated and available for use, and an order queue for each of the pick stations defining a sequence of multiple orders previously assigned to each of the pick stations and predicted durations to complete the packaging of the respective sequence of multiple orders; predicting, utilizing the order prioritization in relation to product inventory information, a duration to retrieve a set of one or more products of a first order to be delivered to the first pick station; predicting a first package availability time, as a function of the fabrication schedule, that the first package is to be available to be delivered to the first pick station; and adjusting at least one of a product retrieval schedule and the fabrication schedule to provide the first package to the first pick station within a threshold buffer period of time of a predicted product availability time of when each of the first set of products of the first order is to be available at the first pick station. Some embodiments can estimate a time difference between the predicted product availability time and the first package availability time, and assign a first package buffer station as a function of the estimated time difference to ensure the first package is available at the first pick station at the predicted product availability time.

In some implementations, methods are provided that can include: controlling the PR system in response to a notification from the first pick station that a second package is ready for transport; identifying that the second package is associated with a second order that includes an additional product to be added to the second package at a different facility; and controlling a package routing system and transporting the second package from the first pick station to a storage location of the PR system in preparation for cooperating the second package with one or more other partially loaded packages to be routed to the different facility. In some embodiments, methods include: identifying, in completing a packaging of a second order, that a second package was previously added to the PR system in a partially loaded state with one or more previously loaded products; controlling the PR system, in completing the packaging of the second order as a function of the order prioritization and the orders scheduled, and retrieving the second package from a storage location of the PR system and route the second package to the first pick station; and controlling the PR system in retrieving one or more additional products and routing the one or more additional products to the first pick station to synchronize, within an availability threshold of time, the availability of the one or more additional products at the first pick station and the availability of the second package at the first pick station.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An order packaging control system, comprising:
a product packaging (PP) control circuit comprising at least one processor and memory communicatively coupled with the at least one processor, the PP control circuit configured to communicatively couple over one or more distributed communication networks with:
an automated custom package fabrication (CPF) system configured to fabricate on demand custom packages according to custom sizing as a function of one or more products intended to be shipped;
an automated product retrieval (PR) system configured to autonomously retrieve one or more products of orders being received over time;
pick stations cooperated with the CPF system and the PR system; and
a set of sensor systems configured to detect positions of custom packages and products as they are transported to and from the pick stations;
wherein the PP control circuit is configured to:
receive over time, from one or more product order systems, the orders;
prioritize the orders as a function of the one or more products of each of the orders and inventory levels, and define an order fulfillment sequence based on the order prioritization;
track, based on sensor data, states of the PR system and the CPF system and determine product retrieval timing of when the one or more products for each of the orders is to be retrieved as a function of the order prioritization, and correspondingly determine fabrication timing of when the CPF system is to fabricate corresponding packaging as a function of a package fabrication queue; and
control both the PR system and the CPF system in controlling synchronous operation of the PR system and the CPF system, as a function of the tracking and order prioritization, to synchronize an availability of the one or more products of a first order of the orders at a first pick station of the pick stations and an availability of a first custom package at the first pick station.

2. The system of claim 1, further comprising:
the pick stations are each configured to buffer and temporarily hold different queued packages while other packages continue to be delivered to the respective pick station and one or more other products are packaged with each of the other packages, wherein the different queued packages are temporarily held at the respective pick station in accordance with a station package queue as a function of the synchronized control of the PR system and the CPF system in positioning the respective queued packages to be available when the one or more products of a respective one of the orders are available to be packaged in a respective one of the queued packages.

3. The system of claim 2, wherein the pick stations comprise package buffer stations each configured to receive and temporarily hold at least one of the queued packages and from which buffered packages are subsequently retrieved in response to a product of an order with which the respective buffered package is available at the respective pick station.

4. The system of claim 3, wherein the pick stations each comprise a pick station control circuit configured to control movement of the packages at the respective pick station to transition a first partially loaded package associated with a first order to one of the package buffer stations until an additional product for the first order is subsequently received at the respective pick station.

5. The system of claim 4, further comprising:
a package transfer system configured to automate the movement of the respective queued packages between one or more packing positions and the package buffer stations of the respective pick station in response to an instruction from the pick station control circuit, based on the tracking, that the corresponding products of the order associated with the respective queued package are predicted to be available to be packaged with the respective queued package.

6. The system of claim 2, wherein:
the pick stations each comprise product buffer stations configured to receive and temporarily hold multiple different queued products, while the other products continue to be delivered to the respective pick station and packaged with the other packages, wherein the multiple different queued products are temporarily held in the product buffer stations in accordance with the station package queue as a function of the synchronized control of the PR system and the CPF system in positioning the respective queued products to be available when the one or more packages associated with one of the orders are available at the respective pick station to receive respective one or more of the queued products.

7. The system of claim 6, wherein the PP control circuit implements a buffering control application accessing inventory information about inventory quantities and locations of available products, a fabrication schedule defining a schedule and expected timing of when respective custom packages are to be fabricated and available for use, and an order queue for each of the pick stations defining a sequence of multiple orders previously assigned to each of the pick stations and predicted durations to complete the packaging of the respective sequence of multiple orders;
wherein the PP control circuit in applying the buffering control application is configured to:
utilize the order prioritization in relation to product inventory information to predict a duration to retrieve a set of one or more products of a first order to be delivered to the first pick station; and
predict a first package availability time, as a function of the fabrication schedule, that the first package is predicted to be available to be delivered to the first pick station, and adjust at least one of a product retrieval schedule and the fabrication schedule to provide the first package to the first pick station within a threshold buffer period of time of a predicted product availability time of when each of the first set of products of the first order is to be available at the first pick station.

8. The system of claim 7, wherein the buffering control application is further configured to estimate a time difference between the predicted product availability time and the first package availability time, and assign a first package buffer station as a function of the estimated time difference to ensure the first package is available at the first pick station at the predicted product availability time.

9. The system of claim 1, wherein the PP control circuit is further configured to control the PR system in response to a notification from the first pick station that a second package is ready for transport and further identify that the second package is associated with a second order that includes an additional product to be added to the second package at a different facility, and control a package routing system to transport the second package from the first pick station to a storage location of the PR system in preparation for cooperating the second package with one or more other partially loaded packages to be routed to the different facility.

10. The system of claim 1, wherein the PP control circuit is further configured to:
identify, in completing a packaging of a second order, that a second package was previously added to the PR system in a partially loaded state with one or more previously loaded products; and
control the PR system, in completing the packaging of the second order, as a function of the order prioritization and the orders scheduled to be completed at the first pick station to:
retrieve the second package from a storage location of the PR system and route the second package to the first pick station; and
retrieve one or more additional products and route the one or more additional products to the first pick station to synchronize, within an availability threshold of time, the availability of the one or more additional products at the first pick station and the availability of the second package at the first pick station.

11. A method of fulfilling product orders, the method comprising:
receiving over time, at a product packaging (PP) control circuit and from one or more product order systems, orders for products from a retailer, wherein each order is requesting one or more of the products, wherein the PP control circuit is configured to communicatively couple over one or more distributed communication networks with an automated custom package fabrication (CPF) system configured to fabricate on demand custom packages according to custom sizing as a function of one or more products intended to be shipped, and an automated product retrieval (PR) system configured to autonomously retrieve one or more products of orders being received over time;
prioritizing the orders as a function of the one or more products of each of the orders and inventory levels, and defining an order fulfillment sequence based on the order prioritization;
tracking, based on sensor data received from a set of sensor systems configured to detect positions of custom packages and products as they are transported to and from pick stations, states of the PR system and the CPF system and determining product retrieval timing of when the one or more products for each of the orders is to be retrieved as a function of the order prioritization, and correspondingly determining fabrication timing of when the CPF system is to fabricate corresponding packaging as a function of a package fabrication queue; and
controlling both the PR system and the CPF system in controlling synchronous operation of the PR system and the CPF system, as a function of the tracking and order prioritization, to synchronize an availability of the one or more products of a first order of the orders at a first pick station of the pick stations and an availability of a first custom package at the first pick station.

12. The method of claim 11, further comprising:
buffering and temporarily holding different queued packages at each of the pick stations while other packages continue to be delivered to the respective pick station and one or more other products are packaged with each of the other packages, wherein the buffering comprises temporarily holding multiple different queued packages at the respective pick station in accordance with a station package queue as a function of the synchronized control of the PR system and the CPF system in positioning the respective queued packages to be available when the one or more products of a respective one of the orders are available to be packaged in a respective one of the queued packages.

13. The method of claim 12, wherein the buffering comprises:
temporarily holding at least one of the queued packages in one or more of package buffer stations of each of the pick stations; and
subsequently retrieving buffered packages from the package buffer stations in response to a product of an order with which the respective buffered package corresponds is available at the respective pick station.

14. The method of claim 13, further comprising:
controlling, by a pick station control circuit of a respective pick station, movement of the packages at the respective pick station to transition a first partially loaded package associated with a first order to one of the package buffer stations until an additional product for the first order is subsequently received at the respective pick station.

15. The method of claim 14, further comprising:
predicting, based on the tracking, that the corresponding products of the order associated with the respective queued package are predicted to be available to be packaged with the respective queued package; and
controlling, based on the predicted availability of the corresponding products of the order, a package transfer system and automating the movement of the respective queued packages between one or more packing positions and the buffer stations of the respective pick station.

16. The method of claim 12, further comprising:
receiving and temporarily holding in product buffer stations of the pick stations one or more of multiple different queued products, while the other products continue to be delivered to the respective pick station and packaged with the other packages; wherein temporarily holding the products comprises temporarily holding the multiple different queued products in accordance with the station package queue as a function of the synchronized control of the PR system and the CPF system in positioning the respective queued products to be available when the one or more packages associated with one of the orders are available at the respective pick station to receive respective one or more of the queued products.

17. The method of claim 16, further comprising:
accessing inventory information about inventory quantities and locations of available products, a fabrication schedule defining a schedule and expected timing of when respective custom packages are to be fabricated and available for use, and an order queue for each of the pick stations defining a sequence of multiple orders previously assigned to each of the pick stations and predicted durations to complete the packaging of the respective sequence of multiple orders;
predicting, utilizing the order prioritization in relation to product inventory information, a duration to retrieve a set of one or more products of a first order to be delivered to the first pick station;
predicting a first package availability time, as a function of the fabrication schedule, that the first package is to be available to be delivered to the first pick station; and
adjusting at least one of a product retrieval schedule and the fabrication schedule to provide the first package to the first pick station within a threshold buffer period of time of a predicted product availability time of when each of the first set of products of the first order is to be available at the first pick station.

18. The method of claim 17, further comprising:
estimating a time difference between the predicted product availability time and the first package availability time; and
assigning a first package buffer station as a function of the estimated time difference to ensure the first package is available at the first pick station at the predicted product availability time.

19. The method of claim 11, further comprising:
controlling the PR system in response to a notification from the first pick station that a second package is ready for transport;
identifying that the second package is associated with a second order that includes an additional product to be added to the second package at a different facility; and
controlling a package routing system and transporting the second package from the first pick station to a storage location of the PR system in preparation for cooperating the second package with one or more other partially loaded packages to be routed to the different facility.

20. The method of claim 11, further comprising:
identifying, in completing a packaging of a second order, that a second package was previously added to the PR system in a partially loaded state with one or more previously loaded products;
controlling the PR system, in completing the packaging of the second order as a function of the order prioritization and the orders scheduled, and retrieving the second package from a storage location of the PR system and route the second package to the first pick station; and
controlling the PR system in retrieving one or more additional products and routing the one or more additional products to the first pick station to synchronize, within an availability threshold of time, the availability of the one or more additional products at the first pick station and the availability of the second package at the first pick station.
